(19) United States
(12) Patent Application Publication
(10) Pub. No.: US 2012/0186147 A1
(43) Pub. Date: Jul. 26, 2012

(54) PORTABLE HYDROSEEDER SEED, MULCH AND FERTILIZER WATER DISSOLVABLE PACKET

(76) Inventor: Anthony Michael Crivello, Winchester, CA (US)

(21) Appl. No.: 13/353,247

(22) Filed: Jan. 18, 2012

Related U.S. Application Data
(60) Provisional application No. 61/435,499, filed on Jan. 24, 2011.

(51) Int. Cl. A01G 1/00

(52) U.S. Cl. 47/9

(57) ABSTRACT

A self-contained hydroseeding packet comprised of seed, mulch, fertilizer and optional color, that when combined with water dissolves in a slurry for use in a portable hydroseeding system.

### CROSS REFERENCE TO RELATED APPLICATIONS

The present application claims priority from U.S. Provisional Patent Application 61/435,499, filed Jan. 24, 2011, entitled, “Portable Hydroseeder Seed, Mulch and Fertilizer Water Dissovable Packet”. The “Portable Hydroseeder Seed, Mulch and Fertilizer Water Dissolvable Packet” works in concert with International Application Number: PCT/US2009/051178, entitled “Portable Hydroseeder” (Priority Data U.S. Provisional Patent No. 61/082,455 Jul. 21, 2008 entitled “A spot hydroseeder/fertilizer that a typical homeowner can connect to a garden hose for spot seeding a lawn, a slope, ground cover, flower beds, pastures, herb gardens or virtually any seed one would like to propagate. You may also fertilize any plot of earth by using a granulated or liquid fertilizer.” and U.S. Provisional Patent No. 61/208,508 Feb. 25, 2009, entitled “A hand-held spot hydroseeder that a typical homeowner can connect to a garden hose for spot seeding, for a lawn, slope, ground cover, flower beds, pastures, herb gardens or virtually any seed one would like to propagate”) the contents of which are incorporated herein by reference in their entirety.

### FIELD

The invention pertains to hydroseeding and more specifically a self-contained hydroseeding packet comprising seed, mulch, and fertilizer that when combined with water dissolves into a slurry for use in a portable hydroseeding system.

### BACKGROUND

Hydroseeding (or hydraulic mulching seeding, hydro-mulching, hydroseeding) is a planting process that uses a slurry of seed, fertilizer and mulch. The slurry is transported in a housing, either truck-mounted or trailer-mounted and sprayed over prepared ground in a uniform layer. Alternatively, helicopters and aircraft can be used where larger areas must be covered, such as, for example, burned wilderness areas after a fire. Hydroseeding is an alternative to the traditional process of broadcasting or sewing dry seed and promotes quick germination and inhibits soil erosion. Hydroseeding is used to seed grass on commercial sites (highways/motorways etc.), golf courses, lawns and areas too large, inaccessible or unsuitable for conventional methods. Starting a lawn by hydroseeding is considerably cheaper than laying sod/turf and quicker than using dry seed. It is also used to spread mixtures of wildflowers and tree/shrub seeds or turf grasses for erosion control. Hydroseeding typically has similar cost to dry seeding techniques that combine seed with straw mulch. Further, the hydroseeding slurry is weed free whereas straw mulch can contain weeds. Also, hydroseeding is typically less than one quarter the cost of laying sod.

Disadvantageously, there has never been a portable hydroseeder due to the pressure required to eject the mulch. As described in U.S. Pat. No. 3,717,285, hydroseeding is currently done by hiring a contractor that has a truck with separate housings for the water and dry ingredients (seed, mulch, fertilizer, color etc) and an agitator pump to mix the water and the dry ingredients to produce a slurry that can be spread over a large area. U.S. Pat. No. 4,913,356 describes a portable seeding device that uses suction, using the venturi effect, to lift a mixture of water and seed from a jar. The constriction required to lift the seed and water out of the jar using the venturi effect is insufficient to allow any mulch to be added to the jar. Additionally, the amount of seed and mulch required to cover at least a one square foot area would make the jar extremely large and unwieldy.

However, as described in patent application PCT/US09/51178 and its corresponding U.S. patent application Ser. No. 13/001,684, both applications which are incorporated in their entirety herein, there exists a portable hydroseeding system capable of overcoming the deficiencies in the prior art. Disadvantageously, there currently only exists premixed slurry components or individual components that a user must load by hand. The premixed slurry components usually come in a large plastic bag that is unwieldy for placing into the compartment of a portable hydroseeder. The individual components must first be measured and mixed in the correct amounts before being placed into the portable hydroseeder. Also, the process of filling or refilling the portable hydroseeder can involve excess spillage of the slurry material and the user getting their hands and potentially their clothes dirty while trying to fill the portable hydroseeder.

Therefore, there is a need for a self-contained hydroseeding packet comprising seed, mulch and fertilizer that when combined with water dissolves in a slurry for use in the portable hydroseeding system described in the incorporated patent applications.

### DRAWINGS

These and other features, aspects and advantages of the present invention will become better understood with regard to the following description, appended claims, and accompanying FIGURE where:

FIG. 1 is a diagram of a self-contained hydroseeding packet comprising seed, mulch and fertilizer that when combined with water dissolves in a slurry for use in a portable hydroseeding system.

### DETAILED DESCRIPTION

The present invention solves the problems with the prior art by providing a self-contained hydroseeding packet comprising seed, mulch and fertilizer that when combined with water, dissolves into a slurry for use in a portable hydroseeding system. In one embodiment the hydroseeding packet comprises a packet that has the proper mixture of seed, fertilizer and mulch so that the packet can be quickly loaded into the portable hydroseeder for use by the user to plant an area. Optionally the packet can also comprise a coloring so that the user can identify areas previously seeded.

As used in this disclosure, except where the content requires otherwise, the term: “comprise” and variations of the term, such as “comprising”, “comprises” and “comprised” are not intended to exclude other additives, components, integers or steps.

The term “slurry” refers to the mixture of water, seed and mulch with other additives, such as, fertilizer, coloring agent and weed killer or pre-made mixtures, such as, for example, Scott's Patchmaster (a registered trademark) products among others.

The term “packet” refers to a self-contained device that refers to a slurry that is held together by a binding means.

The following description, specific details are given to provide a thorough understanding of the embodiments. However, it will be understood by one of ordinary skill in the art that the embodiments can be practiced without these specific details. For example, circuits can be shown in block diagrams in order not to obscure the embodiments in unnecessary detail. In other instances, well-known structures and techniques may not be shown in detail.

The term “membrane” refers to the self-contained device for containing the pre-measured mixture of seed, mulch and fertilizer, and optional color.

Also, it is noted that the embodiments can be described as a process that is depicted as a flowchart, a flow diagram, a structure diagram, or a block diagram. Although a flowchart can describe the operation as a sequential process, many of the operations can be performed in parallel or concurrently. In addition, the order of the operations can be rearranged. A process is terminated when its operations are completed.

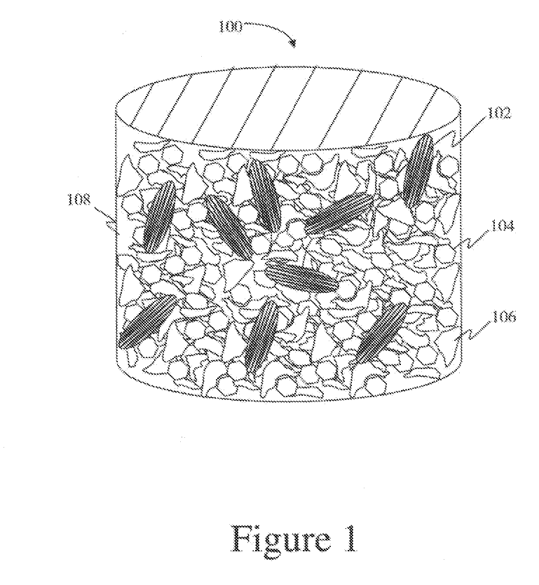

As seen in FIG. 1, there is shown a diagram 100 of a self-contained hydroseeding packet comprising seed, mulch and fertilizer that when combined with water dissolves into a slurry for use in a portable hydroseeding system according to one embodiment of the present invention. The hydroseeding packet 100 comprises seed 102, fertilizer 104, and mulch 106. The seed 102, fertilizer 104, and mulch 106 are bound by binding agent 108. The binding agent can comprise a water-soluble paper, polyvinyl alcohol, quick-dissolving gelatin, starch among other binding agents. Preferably, the binding agent is quickly dissolved in water and biodegradable. In a preferred embodiment the binding agent is polyvinyl alcohol.

The hydroseeding packet 100 comprises sufficient seed, mulch and fertilizer to spread over a (1) one foot square area. A typical mixture would comprise approximately five and four-tenths of one (1) ounce of cellulose mulch, one (1) and six-tenths of one (1) ounce of starter fertilizer, and one (1) and six-tenths of one (1) ounce of turf fescue lawn seed. As can be appreciated, there is an infinite potential of seed, mulch and fertilizer mixtures that can be made. However, those with skill in the art with reference to this disclosure will understand that the seed being planted (grass, flower, vegetable, etc) will determine the optimum mixture to ensure maximum yield from the hydroseeding.

Additionally, the hydroseeding packet 100 is shaped for quickly inserting the packet into the portable hydroseeder so that the user can readily seed larger areas, such as, for example a flower bed without the need to manually mix the slurry prior to placing it in the portable hydroseeder.

Additionally, there is provided a method for making a self-contained hydroseeding packet. The method comprises first measuring the amount of seed to include in the packet and storing the seed in the temporary holding container. Then, a measured amount of fertilizer is placed into the temporary holding container. Next, a measured amount of mulch is placed into the temporary holding container. Optionally a measured amount of coloring agent, weed killer, pesticides and insecticide and other additives that are conducive to maximize the seeds' growth can be added to the temporary holding container. Then, the contents of the temporary holding container are thoroughly mixed until the materials are homogenously distributed throughout. Finally, the mixture is transferred to a packing device where the mixture is portioned out to the correct amounts for the size of the portable hydroseeder being used. Then the homogenous mixture is bound into the packet shape with a binding agent. The binding agent can be water soluble liquid that forms into a solid or into a water soluble outer material, such as, for example, water-soluble paper. Preferably, the binding agent used will be non-toxic and biodegradable. Additionally, the measurements of all materials included in the packet can be weight, volume or both by weight and volume.

Although the present invention has been discussed in considerable detail with reference to certain preferred embodiments, other embodiments are possible. Therefore, the scope of the appended claims should not be limited to the description of the preferred embodiments combined in this disclosure. All references sited herein are incorporated by reference in their entirety.

What is claimed is:

1. A self-contained hydroseeding packet comprising of seed, mulch, fertilizer, optional color, and tacifier or binding agent, that when combined with water dissolves into a slurry for use in a portable hydroseeding system.
a. a water dissolvable membrane;
b. a seed containing a plant
c. a mulch containing a fiber
d. a fertilizer
e. a color
f. a tacifier
g. a binder

2. A self-contained hydroseeding packet of claim 1, where the the water dissolvable membrane is selected from a group consisting of polyvinyl alcohol (PVOH), gelatin (food grade or non food grade), soap, glue, water dissolvable paper, wax or binder.

3. A method of using a water dissolvable seed pack hydroseeding system, the method comprising the steps of:
a. remove thatch or dead vegetation from one or more than one areas to be seeded;
b. loosening soil for the one or more than one areas to be seeded;
c. placing the hydroseeder approximate to the one or more than one areas to be seeded;
d. connecting the hydroseeder to the propellant source;
e. opening the hydroseeder;
f. adding water dissolvable seed pack containing the seed, mulch and fertilizer in one step;
g. closing the hydroseeder;
h. open the inlet valve starting the flow of water to fill halfway;
i. agitate to a slurry, top off with water;
j. open the outlet control valve;
k. apply the slurry to the loosened earth until the housing becomes empty or the slurry is free of seed;
l. repeat steps c through l until all areas are seeded.
